(19) United States
(12) Patent Application Publication
(10) Pub. No.: US 2026/0348360 A1
(43) Pub. Date: Nov. 5, 2026

(54) METHOD FOR HANDLING A WIND TURBINE BLADE USING A CRANE SYSTEM

(71) Applicant: Vestas Wind Systems A/S, Aarhus N. (DK)

(72) Inventor: Ibai Irigoyen Ulayar, Aarhus C (DK)

(73) Assignee: Vestas Wind Systems A/S, Aarhus N. (DK)

(21) Appl. No.: 19/118,805

(22) PCT Filed: Oct. 9, 2023
(86) PCT No.: PCT/DK2023/050240

§ 371 Date: Apr. 7, 2025

(30) Foreign Application Priority Data
Oct. 11, 2022 (DK) PA2022 70492

(51) Int. Cl. F03D 13/10; B66C 23/18; B66C 23/20; F03D 80/50

(52) U.S. Cl. CPC F03D 13/104; B66C 23/185; B66C 23/207; F03D 80/502; F05B 2230/61; F05B 2230/70

(57) ABSTRACT

A method is provided of handling a wind turbine blade (20) of a wind turbine (10). The wind turbine (10) includes a tower (12) and a nacelle (14) connected to the tower (12) with the wind turbine blade (20) being configured to be rotatably attached to the nacelle (14). The method includes providing a first crane (38) supported from the nacelle (14) and including a first attachment structure (70) and a second crane (78) including a second attachment structure (92). The method includes attaching the first attachment structure (70) to the wind turbine blade (20) and the second attachment structure (92) to the wind turbine blade (20). The method further includes operating the nacelle (14) or the first crane (38) and the second crane (78) to arrange the wind turbine blade (20) in an oblique angular position and attaching or detaching the wind turbine blade (20) respectively to or from the nacelle (14) while the wind turbine blade (20) is arranged in the oblique angular position.

### TECHNICAL FIELD

This invention relates generally to wind turbines, and more particularly to a method for replacing a wind turbine blade using both a nacelle-mounted crane and a ground-based crane.

### BACKGROUND

Wind turbines are used to produce electrical energy using a renewable resource and without combusting a fossil fuel. Generally, a wind turbine converts kinetic energy from the wind into electrical power. A horizontal-axis wind turbine includes a tower, a nacelle located at the apex of the tower, and a rotor having a plurality of blades and supported in the nacelle by means of a shaft. The shaft couples the rotor either directly or indirectly with a generator, which is housed inside the nacelle. Consequently, as wind forces the blades to rotate, electrical energy is produced by the generator. Wind turbines may be located either on a land mass (onshore) or within a body of water (offshore).

Like all mechanical machinery, periodic maintenance, refurbishing or repair is needed for wind turbines, which includes the need to repair or refurbish the blades of the wind turbine. When a wind turbine blade cannot be repaired or refurbished while the blade is attached to the hub, it is necessary to remove the blade from the wind turbine and lower it to the ground where the necessary work may be performed. Upon completion of the repair work, the repaired blade, or a new blade, is raised to the nacelle and reattached to the hub.

As electrical energy demands have increased over the past years, the size of wind turbines have also increased so that they may produce additional electrical energy. Consequently, as wind turbines increase in size, the physical dimensions and weight of wind turbine components, including the blades, also increase in size. In that regard, large wind turbine blades can have a length of greater than 50 meters, for example, and may be on the order of 80 meters. In any event, the large size and weight of modern wind turbine blades makes raising and lowering of the blades for installation, repair or maintenance challenging.

One approach for handling large wind turbine blades is to use a large, ground-based “crawler” crane which, in many cases, is taller than the wind turbine. Such cranes are costly to rent and operate, have a lengthy set-up time, and require a significant amount of space to operate. As a result, maintenance and installation downtimes in which the wind turbine is not producing energy can be lengthy, leading to an even greater cost of performing blade repair and maintenance activities.

Another approach for handling wind turbine blades is to use a crane located on the wind turbine. However, for large wind turbine blades in particular, the reach of the crane boom needs to be quite long. As such, the wind turbine blade needing removed is typically placed in a vertical orientation (i.e., a 6 o'clock position) for removal and lowered straight down. Furthermore, for large wind turbine blades, it is often unfeasible to locate a crane large enough to handle the loads involved with lifting the blade on the wind turbine.

Therefore, a need exists for a new system and method for replacing large wind turbine blades in a timely and cost effective way.

### SUMMARY

According to one aspect of the invention, an improved method of handling a wind turbine blade of a wind turbine is disclosed. The wind turbine may include a tower and a nacelle connected to the tower with the wind turbine blade configured to be rotatably attached to the nacelle. The method includes providing a first crane supported from the nacelle and including a first attachment structure, providing a second crane including a second attachment structure, attaching the first attachment structure to the wind turbine blade, attaching the second attachment structure to the wind turbine blade, operating the nacelle or the first crane and the second crane to arrange the wind turbine blade in an oblique angular position, and attaching or detaching the wind turbine blade respectively to or from the nacelle while the wind turbine blade is arranged in the oblique angular position. In one embodiment, the oblique angular position of the wind turbine blade is about 150° or about 210°. Attaching or detaching the wind turbine blade to or from the nacelle while in the oblique angular position provides better access to the blade for the nacelle-mounted crane, which may be located along a side of the main nacelle unit, to thereby minimize a length that the crane boom must extend to attach to the blade. As such, the moment forces acting on the crane while handling the blade are significantly reduced which results in an increased lifting capacity of the crane to handle larger wind turbine blades.

According to one embodiment of the invention, the second crane may be a ground-based crane operated independently of the first crane. In one exemplary embodiment, the first attachment structure may be a root clamp configured to be attached near a root end of the wind turbine blade and the second attachment structure may be a tip clamp configured to be attached near a tip end of the wind turbine blade.

In accordance with one embodiment, the nacelle may include a main nacelle unit and the first crane may be supported from the main nacelle unit so as to be located along a side of the main nacelle unit. Furthermore, a service unit may be attached to the main nacelle unit when service is required. In that regard, the first crane may be located within the service unit attached to the side of the main nacelle unit.

In another embodiment, handling of the wind turbine blade may include detaching the wind turbine blade from the nacelle. In this embodiment, the method may further include operating the nacelle to arrange the wind turbine blade in the oblique angular position, detaching the wind turbine blade from the nacelle, and operating the first crane and the second crane to lower the wind turbine blade from the nacelle. Moreover, the step of attaching the first attachment structure to the wind turbine blade may further include rotating the blade to a first angular position, attaching the first attachment structure to the wind turbine blade while the blade is at the first angular position, and rotating the blade to a second angular position for attachment of the second attachment structure. The first angular position of the blade may be about 90° or about 270°, for example. Moreover, the second angular position may be different from the first angular position. For example, the second angular position may be the oblique angular position. Alternatively, the second angular position may be about 180°.

In yet another embodiment, operating the first crane and the second crane to lower the wind turbine blade from the nacelle may further include lowering the wind turbine blade from the nacelle in the oblique angular position, rotating the wind turbine blade from the oblique angular position to a horizontal position, and further lowering the wind turbine blade in the horizontal position to a storage location. For example, the step of operating the first crane and the second crane to lower the wind turbine blade from the nacelle may also include lowering the first attachment structure along a substantially vertical movement path from the oblique angular position to the storage position.

According to another exemplary embodiment, handling of the wind turbine blade may include attaching the wind turbine blade to the nacelle. In this embodiment, the method may further include raising the wind turbine blade from a storage location to the nacelle, operating the first crane and the second crane to arrange the wind turbine blade in the oblique angular position, and attaching the wind turbine blade to the nacelle. For example, the step of operating the first crane and the second crane to arrange the wind turbine blade in the oblique angular position may also include raising the wind turbine blade from the storage location in a horizontal position, rotating the wind turbine blade from the horizontal position to the oblique angular position, and attaching the wind turbine blade to the nacelle while the wind turbine blade is at the oblique angular position. Furthermore, the step of operating the first crane and the second crane to arrange the wind turbine blade in the oblique angular position may include raising the first attachment structure along a substantially vertical movement path from the storage position to the oblique angular position.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a perspective view of a wind turbine having a nacelle, illustrating a service unit housing a service crane attached to the side of a main nacelle unit of the nacelle;

FIG. 2 is a perspective view of the wind turbine of FIG. 1, with the blades removed for clarity, illustrating the service unit being hoisted to the main nacelle unit;

FIG. 3 is a close-up, perspective view of the nacelle of the wind turbine of FIG. 1, with the blades removed for clarity;

FIG. 4 is a view similar to FIG. 3, illustrating the service crane in an expanded configuration to be used for handling a wind turbine blade;

FIG. 5 is a partial schematic front view of the wind turbine of FIGS. 1-4, illustrating the rotor blade rotated to a 5 o'clock angular position for replacement or installation of the blade to the rotor hub;

FIG. 6 is a view similar to FIG. 5, illustrating a first step of an exemplary blade replacement process according to an embodiment of the present invention, showing the blade to be replaced rotated to a 3 o'clock angular position for attachment of a root clamp of the service crane to a root portion of the blade;

FIG. 7 is a view similar to FIG. 6, illustrating a second step of the blade replacement process wherein the blade is rotated to the 5 o'clock angular position for attachment of a tip clamp of a ground-based crane to a tip portion of the blade;

FIG. 8 is a view similar to FIGS. 6-7, illustrating lowering of the blade from the rotor hub using both the service crane and the ground-based crane;

FIG. 9 is a view similar to FIGS. 6-8, illustrating the blade being rotated from the angular position to a horizontal position;

FIG. 10 is a view similar to FIGS. 6-9, illustrating the blade rotated to a horizontal position and being lowered by both the service crane and the ground-based crane;

FIG. 11 is a view similar to FIGS. 6-10, illustrating the blade lowered to the ground and supported by storage frames at a storage site; and

FIG. 12 is a perspective view illustrating an exemplary attachment structure for use with a crane.

### DETAILED DESCRIPTION

Embodiments of the present invention are directed to a method of handling a wind turbine blade of a wind turbine. This includes the installation of a new or repaired blade to a nacelle or removal of an existing blade from a nacelle for replacement or maintenance activities. In either case, a first, nacelle-mounted crane, and a second, ground-based crane are operated in unison to handle the blade. For attachment of a blade to the nacelle, the cranes are operated to raise the wind turbine blade to an oblique angular position for attachment to the nacelle. For detachment of a blade from the nacelle, the cranes are operated to lower the wind turbine blade from an oblique angular position from the nacelle. The oblique angular positioning of the blade provides better access to the blade for the nacelle-mounted crane, which may be located along a side of the main nacelle unit, to thereby minimize a length that the crane boom must extend to attach to the blade. As such, the moment forces acting on the crane while handling the blade are significantly reduced. Thus, larger wind turbine blades may be handled by the nacelle-mounted crane due to the oblique angular positioning of the blade. These and other benefits of the present invention will be described in further detail below.

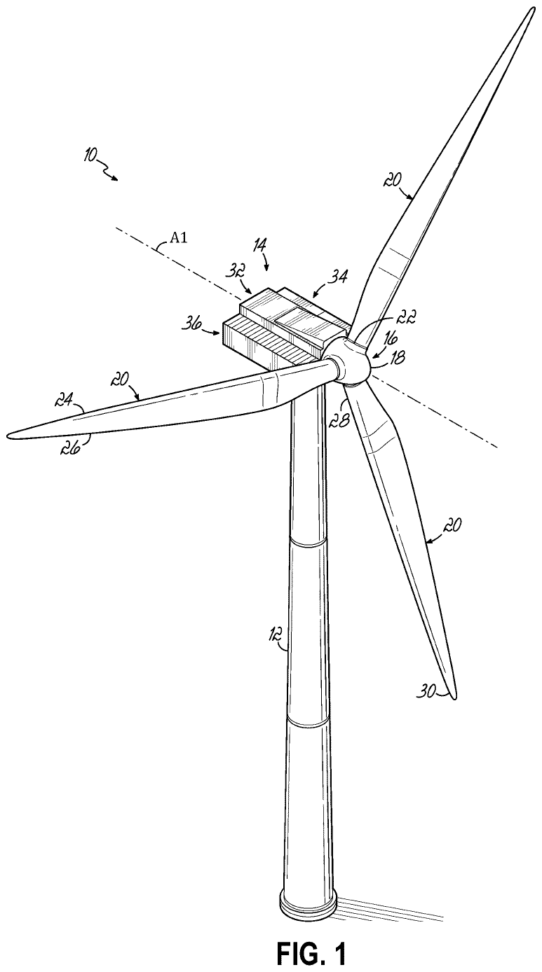

Referring now to FIG. 1, a wind turbine 10 includes a tower 12, a nacelle 14 disposed at the apex of the tower 12, and a rotor 16 operatively coupled to a generator (not shown) housed inside the nacelle 14, and a gearbox (not shown) also housed inside the nacelle 14. In addition to the generator and gearbox, the nacelle 14 may house various other components needed to convert wind energy into electrical energy and to operate and optimize the performance of the wind turbine 10. The tower 12 supports the load presented by the nacelle 14, rotor 16, and other wind turbine components housed inside the nacelle 14, or external to the nacelle 14, and operates to elevate the nacelle 14 and the rotor 16 to a height above ground level or sea level, as may be the case, at which air currents having lower turbulence and higher velocity are typically found. The nacelle 14, and more particularly the rotor 16 defines a rotation axis A1 of the wind turbine 10 that is generally aligned with the direction of the oncoming wind during the operation of the wind turbine 10.

The rotor 16 may include a rotor hub 18 and a plurality of blades 20 attached to the rotor hub 18 at connection ports 22 distributed about the circumference of the rotor hub 18. In the representative embodiment, the rotor 16 includes three blades 20, however the number may vary. The blades 20, which project radially outward from the rotor hub 18, are configured to interact with passing air currents to produce rotational forces that cause the rotor hub 18 to spin about its longitudinal axis which is coaxial with the rotation axis A1. Each blade 20 may be of any suitable configuration and may include a leading edge 24, a trailing edge 26, a root end region 28, and a tip end region 30. In the embodiment shown, a root of the root end region 28 of each blade 20 is operatively coupled to a respective connection port 22 of the rotor hub 18. The design, construction, and operation of the blades 20 are familiar to a person having ordinary skill in the art of wind turbine design and may include additional functional aspects to optimize performance. For example, pitch angle control of the blades 20 may be implemented by a pitch control mechanism (not shown) responsive to wind velocity to optimize power production in low wind conditions, and to feather the blades 20 if wind velocity exceeds design limitations. To this end, the drawings are not intended to be limiting.

The rotor 16 may be coupled to the gearbox directly or indirectly by a drive shaft (not shown) to form a rotor assembly. Either way, the gearbox transfers the rotation of the rotor 16 through a coupling (not shown) to the generator. Wind exceeding a minimum speed may activate the rotor 16, causing the rotor 16 to rotate in a direction substantially perpendicular to the wind, applying torque to the input shaft of the generator. The electrical power produced by the generator may be supplied to a power grid (not shown) or an energy storage system (not shown) for later release to the grid as understood by a person having ordinary skill in the art. In this way, the kinetic energy of the wind may be harnessed by the wind turbine 10 for power generation.

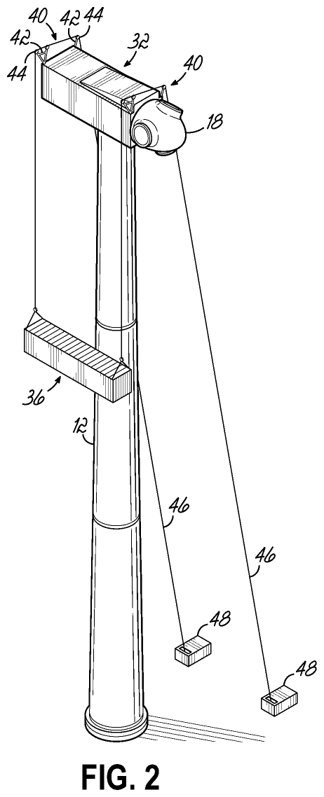

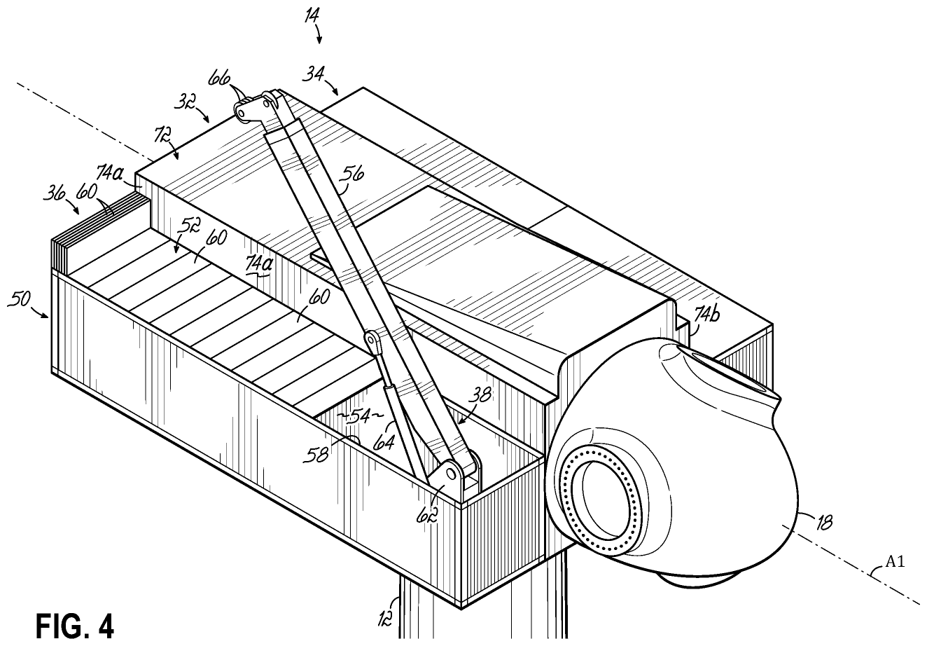

With reference to FIGS. 1 and 2, the nacelle 14 is formed from a main nacelle unit 32 and one or more auxiliary units 34 removably affixed to a side of the main nacelle unit 32. In the embodiment shown, at least one auxiliary unit 34 is a service unit 36 that includes a service crane 38 (e.g., FIG. 4) and any other additional equipment and components needed to handle wind turbine components, such as a blade 20, for example. The service unit 36 may only be temporarily installed to the main nacelle unit 32, such as for the duration of installation and/or maintenance activities on the wind turbine 10. In that regard, as shown in FIG. 2, the main nacelle unit 32 may be equipped with one or more hoist solutions for raising the service unit 36 to the main nacelle unit 32 and for lowering the service unit 36 from the main nacelle unit 32 once the service unit 36 is no longer needed, for example, after the completion of maintenance activities on the wind turbine 10. For example, the hoist solutions may include one or more temporary or permanent hoists 40 for raising the service unit 36 to the main nacelle unit 32 and for lowering the service unit 36 from the main nacelle unit 32. As shown, each hoist 40 includes one or more frame members 42, pulleys 44, and one or more cables 46 routed through the hoist 40 and between a winch 48 and the service unit 36 for raising/lowering the service unit 36. In that regard, the service unit 36 is transported to the wind turbine site and hoisted up to the main nacelle unit 32 using the one or more hoists 40 and releasably attached to the main nacelle unit 32. To this end, it is noted that the plurality of blades 20 have been omitted in FIG. 2 to better illustrate details of each hoist 40 and handling of the service unit 36.

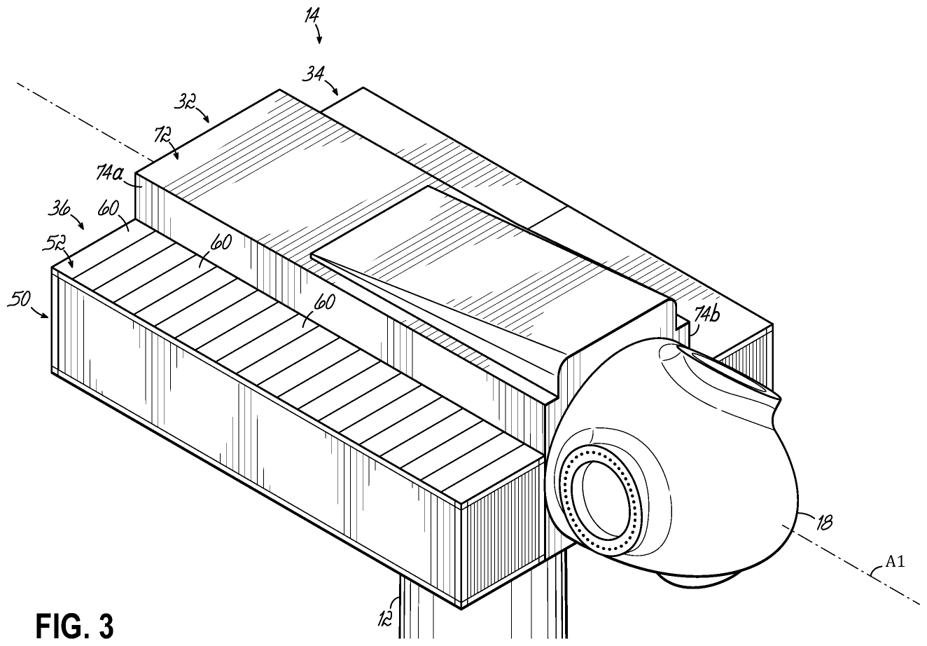

Referring now to FIGS. 3 and 4, the service unit 36 includes a main housing 50 and a removable top wall 52 which together define an interior 54 of the service unit 36. The crane 38 is located within the interior 54 of the service unit 36 and is movable between a collapsed configuration in which the crane 38 is completely enclosed within the interior 54 of the service unit 36, as shown in FIG. 3, and an expanded configuration in which at least a telescoping boom 56 of the crane 38 extends through an opening 58 formed in the top wall 52 of the service unit 36, as shown in FIG. 4. The crane 38 may alternatively be referred to as a containerized crane, for example. As will be described in further detail below, the crane 38 may be configured to be attached directly to the main nacelle unit 32 to form a load path through the main nacelle unit 32 such that the crane 38 remains with and operates from the service unit 36.

With continued reference to FIG. 4, the top wall 52 of the service unit 36 may be removable, or partially removable, so that the crane 38, and more particularly the boom 56 of the crane 38, may extend through the opening 58 in the top wall 52 of the service unit 36 to perform installation and maintenance activities on the wind turbine 10. In this regard, the top wall 52 of the service unit 36 may comprise a plurality of interconnected panels 60 configured to fold or slide relative to one another at one end of the service unit 36 to incrementally retract the top wall 52 to form the opening 58 through which the crane boom 56 may extend during operation, as shown. To this end, a size of the opening 58 may be adjusted as desired. The top wall 52 of the service unit 36 may be partially removed to form the opening 58 for the crane 38, yet still cover a portion of the interior 54 of the service unit 36.

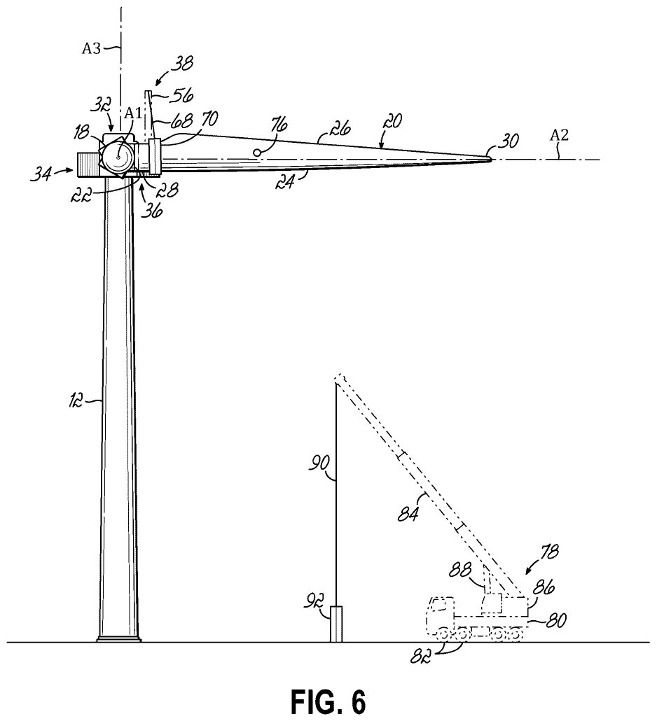

With reference to FIG. 4, the crane 38 includes the boom 56 pivotally connected to a pedestal 62 with pivotal movement of the boom 56 driven by a pair of main hydraulic cylinders 64. The crane pedestal 62 is operatively coupled to a crane base (not shown) via a yaw system. The yaw system may include a yaw bearing driven by a yaw motor for rotating the crane pedestal 62 about the crane base as should be understood by one of ordinary skill in the art. The crane 38 may also include one or more pulleys 66 configured to receive a crane cable 68 (e.g., FIG. 6) that is connected to an attachment structure 70 for handling of a wind turbine blade 20, as will be described in further detail below. To this end, the crane cable 68 may be reeled by a power-driven winch (not shown), as should be understood by a person of ordinary skill in the art.

With continued reference to FIG. 4, the main nacelle unit 32 includes a main housing 72 with opposing main housing outer walls 74a, 74b. In that regard, the service unit 36 is configured to be releasably attached to a main housing outer wall 74a, 74b of the main nacelle unit 32 such that the service crane 38 is positioned alongside of the main nacelle unit 32. Once the service unit 36 is attached to a main housing outer wall 74a, 74b of the main nacelle unit 32, the crane pedestal 62 and base may be directly attached to a base frame of the main nacelle unit 32. While not shown, the base frame of the main nacelle unit 32 is attached to the top of the tower 12. To this end, because the crane 38 is configured to be supported by the base frame in the main nacelle unit 32, the load path for the crane 38 and its associated loads may not be directed through the main housing 50 of the service unit 36 and the main housing outer walls 74a, 74b of the main nacelle unit 32. In this way, the weight of the crane 38 and its payload are not borne by the service unit 36 and the main nacelle unit 32 sidewalls, but instead the crane 38 has a direct load path to the base frame in the main nacelle unit 32 and the tower 12. As such, the crane 38 can accommodate larger sized wind turbine blades 20, for example. Furthermore, locating the crane 38 to a side 74a, 74b of the main nacelle unit 32, rather than a top of the main nacelle unit 32, for example, eliminates the need for a long crane boom 56 for handling of a wind turbine blade 20, as will be described in further detail below.

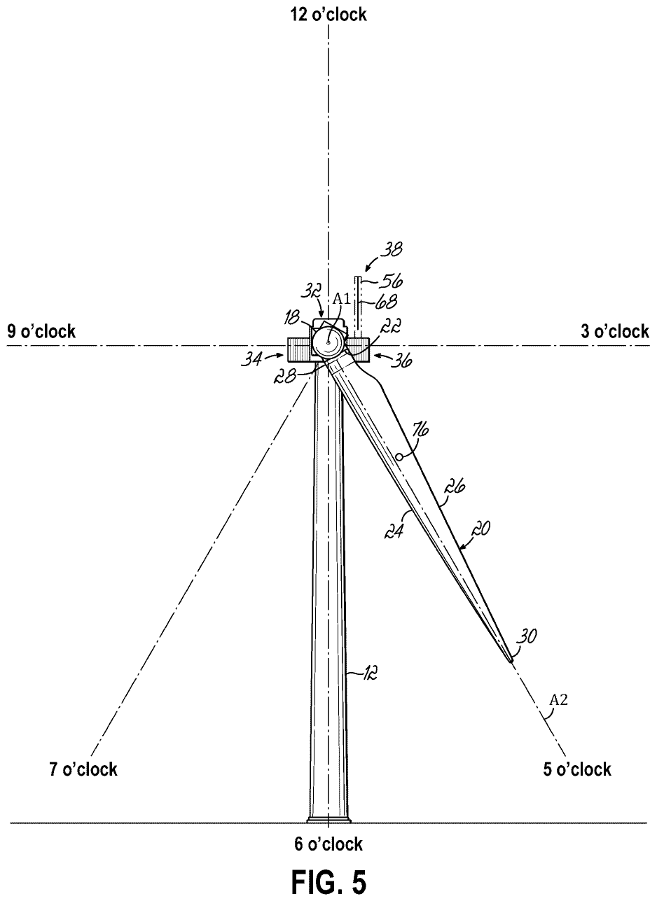

Due to certain constraints, such as the size of the service unit 36, it may be impractical to have a nacelle-mounted crane 38 large enough to solely handle the loads involved with lifting or lowering a large blade 20 to or from the wind turbine 10. For example, to raise and lower a large wind turbine blade 20 that has a length of greater than 50 meters, the crane boom 56 would need to be exceptionally long to reach a center of gravity 76 of the blade 20 (e.g., FIG. 5) to properly handle the blade 20. Such a large crane boom 56 would consequently create a large moment on the crane 38 and thus the main nacelle unit 32, which is also undesirable. As such, a small ground-based crane 78 may be required to assist with lifting or lowering a large blade 20 to or from the rotor hub 18. To this end, the ground-based crane 78 serves to reduce the main load of the blade 20 borne by the service crane 38.

As shown in FIG. 6, for example, the small ground-based crane 78 may be a non-treaded truck crane including a truck body 80 with a plurality of wheels 82. In any event, the ground-based crane 78, and more particularly the truck body 80, is movable relative to the wind turbine 10. The truck body 80 supports the crane 78 which includes a telescoping boom 84 pivotally connected to a crane base 86 with pivotal movement of the boom 84 driven by a hydraulic cylinder 88. The crane base 86 is configured to yaw relative to truck body 80 via a yaw system as should be understood by one of ordinary skill in the art. The truck crane 78 also includes one or more pulleys (not shown) configured to receive a crane cable 90 that is connected to an attachment structure 92 for handling of a wind turbine blade 20, as will be described in further detail below. The crane cable 90 may be reeled by a power-driven winch (not shown), as should be understood by a person of ordinary skill in the art. As will be described in further detail below, the location of the service crane 38 and the orientation of the wind turbine blade 20 to be replaced eliminates the need for a large tread-driven “crawler” crane. To this end, the small ground-based crane 78 serves to handle a partial load of the blade 20 while the service crane 38 handles a main load.

Turning now to FIG. 5, each wind turbine blade 20 defines a longitudinal axis A2 that extends between the root end region 28 and the tip end region 30 of the blade 20. As shown, when each wind turbine blade 20 is attached to a respective connection port 22 of rotor hub 18, the longitudinal axis A2 of each blade 20 may be comparable to a hand on a clock face. In that regard, the rotor hub 18 is rotatable about the rotational axis A1 such that positions of the blades 20 can be described based on a clock face and/or based on angle specifications. In particular, the rotor hub 18 may be lockable in 12 rotor lock positions that correspond to the 12 hours of a clock face. At each lockout position of the rotor hub 18, the longitudinal axis A2 of each blade 20 is oriented at an angular position that corresponds to an hour of a clock face. For example, 0° corresponds to 12 o'clock, 90° corresponds to 3 o'clock, 150° corresponds to 5 o'clock, 180° corresponds to 6 o'clock, 210° corresponds to 7 o'clock, and 270° corresponds to 9 o'clock. While only certain exemplary hours are shown, it is understood that the hours of a clock face are rotationally spaced apart in 30° increments. To this end, it is understood that the rotor lock positions may vary +/−10° due to a certain amount of sag of the wind turbine blade 20 or other uncontrollable variables, such as weather, etc. For example, it may be said that a rotor blade 20 locked at the 5 o'clock position, as shown, may be at an angle of about 150°. In this example, the term about means that the blade 20 is at an angle within a range of between 140° to 160°, or preferably within a range of about 145° to 155°, or even more preferably within a range of about 147° to 153°. To this end, the 5 o'clock position is just one example of the use of the term “about,” and it should be understood that the term equally applies to all angular positions of the blade 20.

Having now described certain details of the wind turbine 10 and the cranes 38, 78, an exemplary sequence whereby the nacelle 14, the service unit crane 38, and the ground-based crane 78 are operated to replace a wind turbine blade 20 will now be described in connection with FIGS. 6-11.

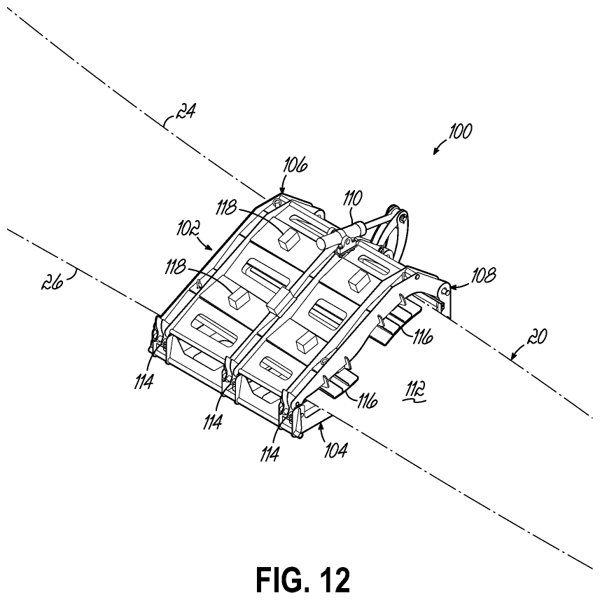

Referring now to FIG. 6, the wind turbine 10 is shown with one wind turbine blade 20 installed to the rotor hub 18. The remaining blades 20 are not shown to better illustrate the method steps, for example. In any event, the wind turbine 10 includes at least one blade 20 that needs to be removed and lowered to the ground for replacement or repair work. In a first step, the rotor hub 18 of the nacelle 14 is rotated to place the blade 20 at the 3 o'clock position, as shown in FIG. 6. When in the 3 o'clock position, the blade 20 has been rotated to about a 90° angular position wherein the longitudinal axis A2 of the blade 20 is generally perpendicular to a longitudinal axis A3 of the tower 12. In an embodiment where the service crane 38 is located on the other side 74a of the main nacelle unit 32, the blade 20 would be rotated to the 9 o'clock or about a 270° angular position. In the exemplary embodiment shown, the rotor hub 18 is locked in the 3 o'clock position so that the attachment structure 70 of the service crane 38 may be attached to the blade 20. As shown, the attachment structure 70 is secured around the blade 20 at the root end region 28. In that regard, the attachment structure 70 may be referred to as a root clamp 70 which will be described in greater detail below with respect to FIG. 12.

As shown in FIG. 6, the blade 20 is rotated to the side 74b main nacelle unit 32 on which the service crane 38 is located. In particular, the blade 20 is rotated to place the root end 28 of the blade 20 directly across from, or in front of, the service unit 36 and the crane 38. When so positioned, it may be said that the root end 28 of the blade 20 is adjacent to the service unit 36 and the crane boom 56. As such, the crane boom 56 may only need to extend 8-10 meters to locate the root clamp 70 in a position to be attached to the blade 20. The short reach distance for the crane boom 56 minimizes the moment forces acting on the crane 38 while raising and lowering the wind turbine blade 20. Once the root clamp 70 is attached to the blade 20, the service crane 38 generally maintains the same extended position of the boom 56 to lower the blade 20 from the nacelle 14, as will be described in further detail below. The root clamp 70 may be attached anywhere between the center of gravity 76 and the root end 28 of the blade 20. However, it is preferable to attach the root clamp 70 closer to the root end 28 of the blade 20, as shown.

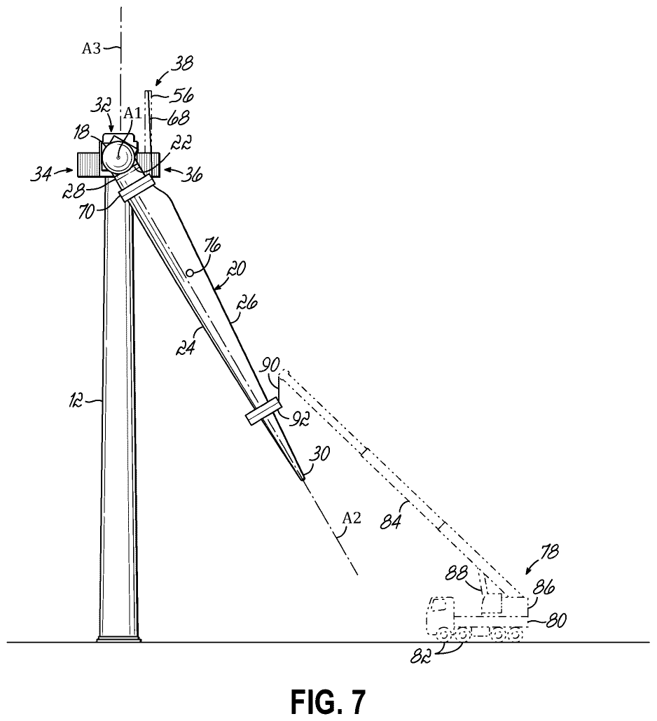

Once the root clamp 70 is attached to the root end 28 of the blade 20, the rotor hub 18 is rotated to place the blade 20 at about the 5 o'clock position, as shown in FIG. 7. When in the 5 o'clock position, the blade 20 has been rotated to place the longitudinal axis A2 of the blade 20 at about a 150° angular position. The rotor hub 18 is then locked in the 5 o'clock position so that the attachment structure 92 of the ground-based crane 78 may be attached to the blade 20. In that regard, the ground-based crane 78 is strategically positioned near the wind turbine 10 to both locate the attachment structure 92 near the blade 20 for attachment thereto and for lowering of the blade 20, as will be described in further detail below. As shown, the attachment structure 92 is configured to be secured around the blade 20 at the tip end region 30. To that end, the attachment structure 92 may be referred to as a tip clamp 92. By placing the blade 20 in the 5 o'clock position, the tip end region 30 of the blade 20 is located closer to the ground and the ground-based crane 78 compared to when the blade 20 is in the 3 o'clock position, for example. As a result, a distance that the ground-based crane boom 84 must reach to locate the tip clamp 92 in a position to be attached to the blade 20 is minimized. Thus, a smaller ground-based crane 78 can be used. Furthermore, when the blade 20 is in the 5 o'clock position, the root clamp 70 remains substantially directly below the service crane 38 such that a length of the boom 56 of the service crane 38 remains substantially unchanged compared to when the root clamp 70 was attached to the blade 20. To this end, once both attachment structures 70, 92 have been attached to the blade 20, as shown, the service crane 38 need only lower the root end 28 of the blade 20 away from the rotor hub 18, as described in further detail below.

In one embodiment, the blade 20 may instead be rotated to a 6 o'clock position (about a 180°) or a 4 o'clock (about a 120°) for attachment of the of the tip clamp 92 to the wind turbine blade 20. In either case, once the tip clamp 92 is attached to the blade 20, the rotor hub 18 is rotated to place the blade 20 at the 5 o'clock position or about the 150° angular position.

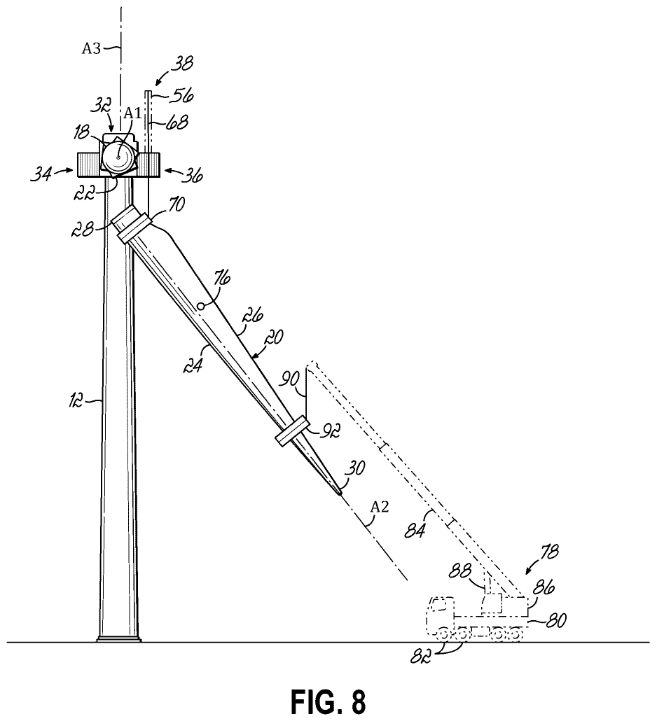

Referring now to FIG. 8, once the root clamp 70 and the tip clamp 92 have been attached to the blade 20, and the blade 20 rotated to the 5 o'clock position or about the 150° angular position, the root end 28 of the blade 20 may be uncoupled from the respective rotor hub 18 connection port 22 such that the weight of the blade 20 is borne by the service crane 38 and the ground-based crane 78. The service crane 38 is then operated to lower the root end 28 of the blade 20 away from the rotor hub 18. In particular, the service crane 38 is operated to lower the root clamp 70 and the root end 22 of the blade 20 along a substantially vertical movement path between the rotor hub 18 and the ground. The vertical movement path may generally be parallel to the longitudinal axis A3 of the tower 12. To this end, the vertical movement path of the root end 22 of the blade 20 is offset to a side of the tower 12 as a result of the crane 38 being located along a side 74b of the nacelle 14. As shown, the blade 20 is initially lowered away from the rotor hub 18 in the 5 o'clock or 150° angular position. Both cranes 38, 78 are operated in unison, albeit independently, to lower the blade 20. That is to say, each crane 38, 78 is an independent lifting mechanism (i.e., one crane 38, 78 is neither connected to nor dependent on movement of the other crane 38, 78 for operation) capable of independently moving the blade 20. However, to achieve the goal of attachment or detachment of the blade 20 from the wind turbine 10, the cranes 38, 78 are operated in unison such that independent operation of one crane 38, 78 is performed in view of the independent operation of the other crane 38, 78 to orient the blade 20 relative to the wind turbine 10.

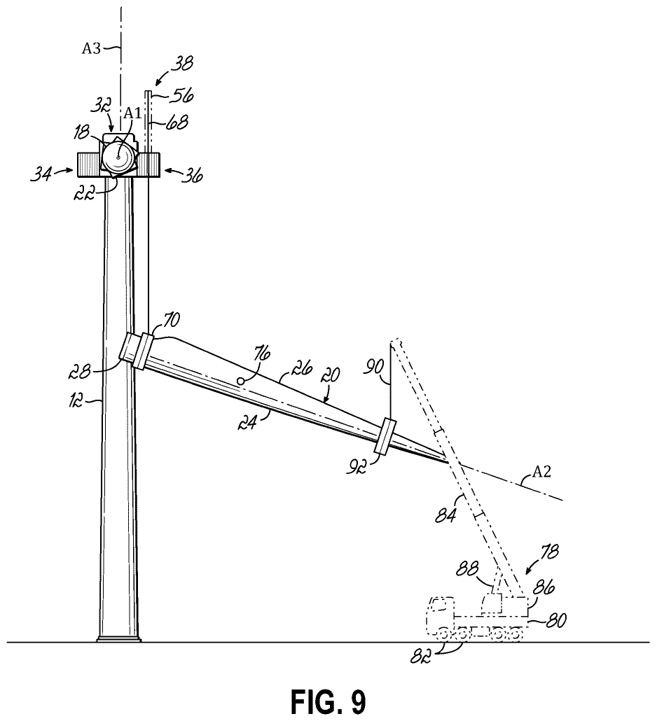

With reference to FIG. 9, while the blade 20 is being lowered, the cranes 38, 78 are operated to rotate the blade 20 from the angular position (e.g., 150°) to a horizontal position (i.e., the longitudinal axis A2 of the blade 20 is generally perpendicular to the longitudinal axis A3 of the tower 12). To rotate the blade 20 to the horizontal position, the service crane 38 is operated to lower the root end 28 of the blade 20 at a rate that is generally greater (i.e., faster) compared to a rate at which the tip end region 30 of the blade 20 is being lowered by the ground-based crane 78. When the blade 20 is being rotated to the horizontal position, a position of the root end 28 of the blade 20 is maintained substantially directly below the service crane 38 so that the length of the service crane boom 56 remains substantially unchanged. In that regard, the service crane 38 is operated to continue to lower the root clamp 70 and the root end 22 of the blade 20 along the substantially vertical movement path between the rotor hub 18 and the ground. That way, the moment forces acting on the service crane 38 and the wind turbine 10 are minimized. In the embodiment shown, the ground base crane 78 is parked such that the truck body 80 is static and the boom 84 of the crane 78 is moved (e.g., extended or retracted) to maintain movement of the root end 28 of the blade 20 along the vertical movement path and substantially directly below the service crane 38. However, in an alternative embodiment, the truck body 80 of the ground-based crane 78 may be moved along the ground, toward or away from the tower 12, for example, to maintain movement of the root end 28 of the blade 20 along the vertical movement path and substantially directly below the service crane 38. To this end, movement of the truck body 80 of the ground-based crane 78 may be in addition to or alternative to movement of the boom 84.

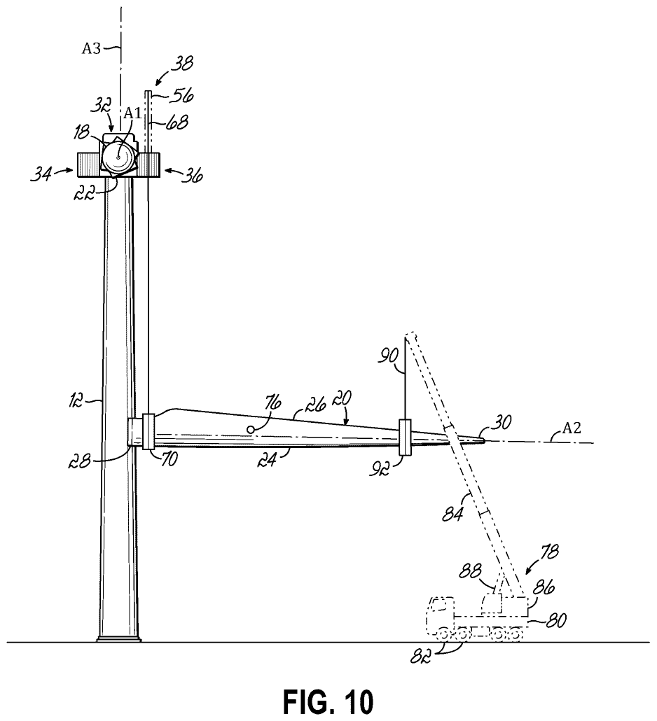

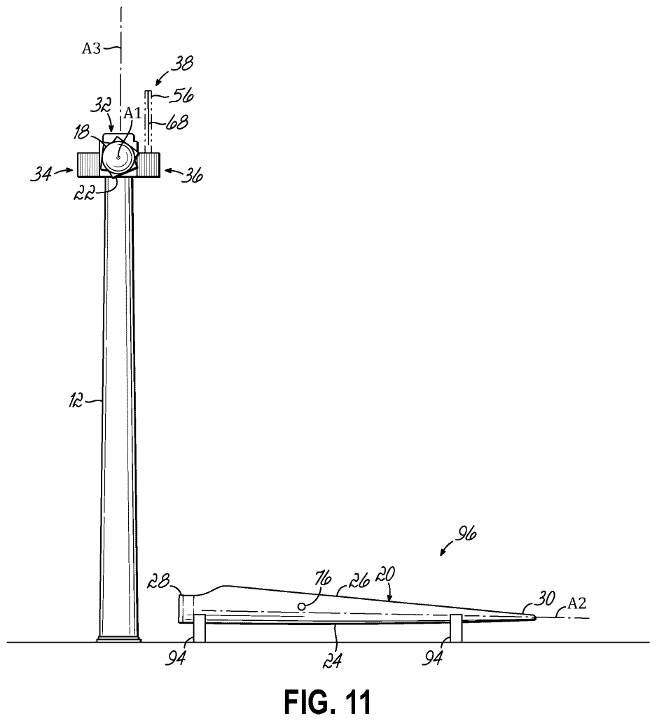

FIG. 10 shows the blade 20 after it has been rotated to the horizontal position in which the longitudinal axis A2 of the blade 20 is generally perpendicular to the longitudinal axis A3 of the tower 12. Once the blade 20 is rotated to the horizontal position, the service crane 38 and the ground-base crane 78 are operated together, albeit independently, to further lower the blade 20 while maintaining the blade 20 in the horizontal position. The blade 20 is lowered into storage cradles 94 at a storage site 96 on the ground for storage, as shown in FIG. 11.

In an alternative embodiment, the blade 20 may be rotated to the side 74a of the main nacelle unit 32 that is opposite to the side 74b of the main nacelle unit 32 on which the service crane 38 is located (i.e., in the 210° position). In that regard, the boom 56 of the service crane 38 may reach or extend over the rotor hub 18 to lower the blade 20 in the same manner as described above with respect to FIGS. 6-11. In this alternative embodiment, while the moment loads a greater than that experienced in the arrangement described above in FIGS. 6-11, the moment loads are believed to remain within the capacity of the service crane 38. However, it should be appreciated that the blade 20 is preferably located on the same side as the service crane 38.

The method steps described above with respect to FIGS. 6-11 are generally performed in reverse order to install a replacement blade or a repaired blade 20 to the rotor hub 18. In that regard, the repaired blade or replacement blade 20 is brought to the storage site 96 and may be stored in storage cradles 94 as shown in FIG. 11, for example. When so positioned, the attachment structure or root clamp 70 of the service crane 38 is attached to the root end 28 of the blade 20 and the attachment structure or tip clamp 92 of the ground-based crane 78 is attached to the tip end region 30 of the blade 20. The cranes 38, 78 are then operated to raise the blade 20 in a horizontal position, as shown in FIG. 10.

With reference to FIG. 9, the service crane 38 is operated to raise the root end 28 of the blade 20 at a rate that is greater (i.e., faster) than a rate at which the tip end region 30 of the blade 20 is being raise by the ground-based crane 78 to thereby rotate the blade 20 from the horizontal position to the 5 o'clock or 150° angular position. In that regard, the ground-based crane 78 may raise the tip end region 30 of the blade 20 at a rate slower compared to a rate at which the root end 28 of the blade 20 is being raised by the service crane 38. Furthermore, the ground base crane 78 is parked such that the truck body 80 is static and the boom 84 of the crane 78 is moved (e.g., extended or retracted) to maintain movement of the root end 28 of the blade 20 along a substantially vertical movement path and substantially directly below the service crane 38 as the blade 20 is being raised. However, in an alternative embodiment, the truck body 80 of the ground-based crane 78 may be moved along the ground, toward or away from the tower 12, for example, to maintain movement of the root end 28 of the blade 20 along the vertical movement path as the blade 20 is being raised. To this end, movement of the truck body 80 of the ground-based crane 78 may be in addition to or alternative to movement of the boom 84. In either case, once the blade 20 is rotated to the preferred angular position, as shown in FIG. 8, the cranes 38, 78 are operated to raise the blade 20 to the rotor hub 18 for attachment of the root end 18 of the blade 20 to the respective connection port 22. To this end, the blade 20 is attached to the rotor hub 18 such that the blade 20 is in the 5 o'clock or 150° angular position, as shown in FIG. 7.

Referring now to FIG. 12, an attachment structure 100 is shown according to an embodiment of the present invention. The attachment structure 100 is representative of the root clamp 70 described above with respect to FIGS. 6-11, but may also be used as the tip clamp 92. As shown, the attachment structure 100 includes a generally C-shaped frame 102 having a lower portion 104 hingeably coupled to an upper portion 106 to define a hinge joint 108 therebetween. The attachment structure 100 includes a hydraulic cylinder 110 configured to selectively rotate the upper portion 106 relative to the lower portion 104 such that a region 112 of the blade 20 (e.g., the root end region 28 or the tip end region 30) may be positioned between the lower and upper portions 104, 106 of the frame 102. The lower and upper portions 104, 106 are generally sized and shaped to collectively wrap around the exterior surface of the blade 20, as shown. The attachment structure 100 may include at least one lock 114 configured to selectively lock the upper portion 106 to the lower portion 104 to retain the blade 20 in the frame 102 while the blade 20 is being raised/lowered using the attachment structure 100.

With continued reference to FIG. 12, the upper and lower portions 104, 106 of the attachment structure 100 each include a plurality of active pads 116 for gripping surfaces of the blade 20. The plurality of active pads 116 are configured to apply the clamping force needed to retain the blade 20 in the attachment structure 100 while the blade 20 is being raised/lowered using the attachment structure 100. In that regard, each active pad 116 includes an actuator 118 for urging the pad 116 toward surfaces of the blade 20. In particular, the actuators 116 actively regulate the clamping force applied to maintain the blade 20 securely in the attachment structure 100 without damaging the blade 20. To this end, the active pads 116 may include a high friction material for gripping surfaces of the wind turbine blade 20.

While the present invention has been illustrated by a description of various preferred embodiments and while these embodiments have been described in some detail, it is not the intention of the Applicant to restrict or in any way limit the scope of the appended claims to such detail. Additional advantages and modifications will readily appear to those skilled in the art. Thus, the various features of the invention may be used alone or in any combination depending on the needs and preferences of the user.

1. A method of handling a wind turbine blade of a wind turbine, the wind turbine comprising a tower and a nacelle connected to the tower, the wind turbine blade configured to be rotatably attached to the nacelle, the method comprising:
providing a first crane supported from the nacelle and including a first attachment structure;
providing a second crane including a second attachment structure;
attaching the first attachment structure to the wind turbine blade;
attaching the second attachment structure to the wind turbine blade;
operating the nacelle or the first crane and the second crane to arrange the wind turbine blade in an oblique angular position; and
attaching or detaching the wind turbine blade respectively to or from the nacelle while the wind turbine blade is arranged in the oblique angular position.

2. The method of claim 1, wherein the oblique angular position of the wind turbine blade is at an angle within a range of between 140° to 160°.

3. The method of claim 1, wherein the first attachment structure comprises a root clamp configured to be attached to a root end of the wind turbine blade and the second attachment structure comprises a tip clamp configured to be attached to a tip end of the wind turbine blade.

4. The method of claim 1, wherein the nacelle includes a main nacelle unit and the first crane is supported from the main nacelle unit so as to be located along a side of the main nacelle unit.

5. The method of claim 4, wherein the first crane is located within a service unit attached to the side of the main nacelle unit.

6. The method of claim 1 wherein handling of the wind turbine blade comprises detaching the wind turbine blade from the nacelle, the method further comprising:
operating the nacelle to arrange the wind turbine blade in the oblique angular position;
detaching the wind turbine blade from the nacelle; and
operating the first crane and the second crane to lower the wind turbine blade from the nacelle.

7. The method of claim 1, wherein attaching the first attachment structure to the wind turbine blade further comprises:
rotating the blade to a first angular position;
attaching the first attachment structure to the wind turbine blade while the blade is at the first angular position; and
rotating the blade to a second angular position for attachment of the second attachment structure, the second angular position being different from the first angular position.

8. The method of claim 7, wherein the second angular position is the oblique angular position.

9. The method of claim 7, wherein the first angular position of the blade is at an angle within a range of between 80° to 100° or at an angle within a range of between 260 to 280°.

10. The method of claim 6, wherein operating the first crane and the second crane to lower the wind turbine blade from the nacelle further comprises:
lowering the wind turbine blade from the nacelle in the oblique angular position;
rotating the wind turbine blade from the oblique angular position to a horizontal position; and
further lowering the wind turbine blade in the horizontal position to a storage location.

11. The method of claim 10, wherein operating the first crane and the second crane to lower the wind turbine blade from the nacelle further comprises:
lowering the first attachment structure along a substantially vertical movement path from the oblique angular position to the storage location.

12. The method of claim 1, wherein handling of the wind turbine blade comprises attaching the wind turbine blade to the nacelle, the method further comprising:
operating the first crane and the second crane to raise the wind turbine blade from a storage location to the nacelle;
operating the first crane and the second crane to arrange the wind turbine blade in the oblique angular position; and
attaching the wind turbine blade to the nacelle.

13. The method of claim 12, wherein operating the first crane and the second crane to arrange the wind turbine blade in the oblique angular position further comprises:
raising the wind turbine blade from the storage location in a horizontal position;
rotating the wind turbine blade from the horizontal position to the oblique angular position; and
attaching the wind turbine blade to the nacelle while the wind turbine blade is at the oblique angular position.

14. The method of claim 12, wherein operating the first crane and the second crane to arrange the wind turbine blade in the oblique angular position further comprises:
raising the first attachment structure along a substantially vertical movement path from the storage location to the oblique angular position.

15. The method of claim 1, wherein the second crane is a ground-based crane operated independently of the first crane, and wherein the first crane and the second crane are operated in unison to handle the wind turbine blade.
